(19) United States
(12) Patent Application Publication
(10) Pub. No.: US 2026/0121024 A1
(43) Pub. Date: Apr. 30, 2026

(54) ANODE ACTIVE MATERIAL, ANODE, AND LITHIUM-ION SECONDARY BATTERY

(71) Applicant: TOYOTA JIDOSHA KABUSHIKI KAISHA, Toyota-shi (JP)

(72) Inventor: Ryoshi OHTA, Susono-shi (JP)

(73) Assignee: TOYOTA JIDOSHA KABUSHIKI KAISHA, Toyota-shi (JP)

(21) Appl. No.: 19/335,364

(22) Filed: Sep. 22, 2025

(30) Foreign Application Priority Data
Oct. 28, 2024 (JP) 2024-189297

(51) Int. Cl. H01M 4/36; C01B 33/02; H01M 4/02; H01M 4/134; H01M 4/38; H01M 4/62; H01M 10/0525; H01M 10/42

(52) U.S. Cl. CPC H01M 4/366; C01B 33/02; H01M 4/134; H01M 4/386; H01M 4/62; H01M 10/0525; H01M 10/4235; C01P 2002/74; C01P 2002/82; C01P 2006/12; C01P 2006/14; C01P 2006/40; H01M 2004/027

(57) ABSTRACT

An anode active material includes porous silicon, and a carbon coating disposed on at least part of the surface of the porous silicon. The specific surface area is 130 m²/g or more, and the proportion of the carbon coating is in the range of 1.5 masse to 12 masse relative to the total mass of the porous silicon and the carbon coating.

### CROSS-REFERENCE TO RELATED APPLICATION

This application claims priority to Japanese Patent Application No. 2024-189297 filed on Oct. 28, 2024. The disclosure of the above-identified application, including the specification, drawings, and claims, is incorporated by reference herein in its entirety.

### BACKGROUND

### 1. Technical Field

The present disclosure relates to anode active materials, anodes, and lithium-ion secondary batteries.

### 2. Description of Related Art

Currently, graphitic anode materials are typically used as the anode active material of lithium-ion secondary batteries; however, the use of porous silicon particles has been proposed. For example, WO 2023/002757 discloses an anode active material including porous silicon particles having a plurality of pores and a carbon material covering at least part of the inner surfaces of the pores. In the anode active material disclosed in WO 2023/002757, the ratio of the specific surface area of the anode active material to the specific surface area of the porous silicon particles is 40% to 99% According to WO 2023/002757, since expansion and contraction of the porous silicon particles that occur during charge and discharge reactions are less likely to be hindered by the carbon material, charge-discharge cycle characteristics are improved.

Japanese Unexamined Patent Application Publication No. 2008-235258 (JP 2008-235258 A) discloses an anode material for lithium-ion secondary batteries that includes porous particles of a metal silicon capable of forming an alloy with lithium, graphite particles, and carbon, and that has a specific surface area of 10 m²/g or less. The anode material disclosed in JP 2008-235258 A is described as having high capacity, low irreversible capacity, and excellent charge-discharge cycle characteristics.

### SUMMARY

However, when porous silicon is used as the anode active material, there has been an issue in that the initial charge-discharge efficiency is poor. An object of the present disclosure is to provide an anode active material, an anode, and a lithium-ion secondary battery that exhibit excellent initial charge-discharge efficiency.

To achieve the above object, the inventors of the present disclosure conducted extensive studies and discovered that setting the proportion of the carbon coating formed on the surface of the porous silicon within a predetermined range reduces the amount of electrolyte absorbed into the pores of the porous silicon is reduced, thereby improving the initial charge-discharge efficiency. As a result, the present disclosure has been completed. The present disclosure encompasses the following.
(1) An anode active material including porous silicon and a carbon coating disposed on at least part of a surface of the porous silicon. The specific surface area is 130 m²/g or more, and the proportion of the carbon coating is in the range of 1.5 mass % to 12 mass % relative to the total mass of the porous silicon and the carbon coating.
(2) In the anode active material according to (1), the pore volume is in the range of 0.16 cm³/g to 0.45 cm³/g.
(3) In the anode active material according to (1) or (2), the intensity ratio of D to G in Raman spectroscopy is in the range of 0.670 to 0.725, where D represents a peak at the D band near 1340 cm⁻¹ and G represents a peak at the G band near 1580 cm⁻¹.
(4) An anode including: an anode material including the anode active material according to any one of (1) to (3); and an anode current collector having the anode material disposed on at least one surface of the anode current collector.
(5) A lithium-ion secondary battery including: a cathode including a cathode active material; the anode according to (4); and an electrolyte layer disposed between the cathode and the anode.

The present disclosure can provide an anode active material, an anode, and a lithium-ion secondary battery that exhibit excellent initial charge-discharge efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing a main part of a lithium-ion secondary battery.

### DETAILED DESCRIPTION OF EMBODIMENTS

Hereinafter, an embodiment of the present disclosure will be described. The following description illustrates an embodiment and is not intended to limit the scope of the present disclosure.

In the present specification, numerical ranges indicated using “to” represent ranges inclusive of minimum and maximum values specified before and after “to”, respectively.

In numerical ranges described in stages in the present specification, the upper or lower limit of one numerical range may be replaced with the upper or lower limit of another numerical range. In addition, in numerical ranges described in the present specification, the upper or lower limit of a numerical range may be replaced with a value disclosed in the examples.

In the present specification, the term “step” may refer not only to an independent step but also to a step that is not clearly distinguishable from other steps, as long as the intended purpose of the step is achieved.

In the present specification, when an embodiment is described with reference to the drawings, the configuration of the embodiment is not limited to the configuration illustrated in the drawings. In addition, the sizes of components shown in the drawings are conceptual, and the relative size relationships among components are not limited to those illustrated in the drawings.

### Anode Active Material

An anode active material of the present disclosure includes porous silicon and a carbon coating provided on at least part of the surface of the porous silicon, has a specific surface area of 130 m²/g or more, and has a carbon coating content of 1.5 mass % to 12 mass % relative to the total mass of the porous silicon and the carbon coating. By using an anode including the anode active material of the present disclosure, a lithium-ion secondary battery with excellent initial charge-discharge efficiency can be obtained. This is presumably because the anode active material of the present disclosure allows the amount of electrolyte irreversibly absorbed into the porous silicon to be reduced while maintaining the mechanical strength of the porous silicon.

### Porous Silicon

The porous silicon used in the anode active material of the present disclosure is not particularly limited, and porous silicon having a three-dimensional network structure may be used. Although not particularly limited, the porous silicon preferably has an average porosity of 30 vol % or more and 95 vol % or less, more preferably 50 vol % or more and 95 vol % or less. The average particle size of the porous silicon is also not particularly limited, but is preferably 0.1 μm or more and 100 μm or less. The average particle size is preferably 0.1 μm or more, more preferably 1 μm or more, and may be 5 μm or more. The average particle size is preferably 10 μm or less, more preferably 5 μm or less, and even more preferably 3 μm or less. The porous silicon may also be of a type that includes skeletal silicon and/or fine silicon particles. In the porous silicon, the pore diameter is preferably 1 nm or more and 1 μm or less, and may be 10 nm or more, 50 nm or more, or 100 nm or more. The pore diameter may be 500 nm or less, 300 nm or less, or 250 nm or less. The porous silicon preferably contains 60 at % or more of silicon (Si), more preferably 80 at % or more, and even more preferably 85 at % or more, in terms of the ratio of elements excluding oxygen. The porous silicon may further contain metal elements such as aluminum (Al), chromium (Cr), titanium (Ti), molybdenum (Mo), niobium (Nb), vanadium (V), and tungsten (W), in addition to silicon (Si). The porous silicon may also contain one or more elements selected from calcium (Ca), copper (Cu), magnesium (Mg), sodium (Na), strontium (Sr), and phosphorus (P). The average particle size of the porous silicon is determined by observing the particles using a scanning electron microscope (SEM), measuring the major axis of each particle as the particle diameter, and calculating the average based on the number of particles. The average porosity of the particles is determined by measurement using a mercury porosimeter.

The method for producing the porous silicon particles is not particularly limited. For example, the porous silicon may be obtained by selectively dissolving and removing elements and/or compounds other than Si from silicon alloy particles containing at least Al and Si. Alternatively, the porous silicon may be obtained by generating Mg vapor by heating magnesium (Mg) metal, reducing silicon oxide contained in porous diatomaceous earth using the Mg vapor to form an intermediate product containing Si and MgO, and then washing the intermediate product with acid to remove the MgO.

### Carbon Coating

In the anode active material of the present disclosure, a carbon coating is provided on at least part of the surface of the porous silicon described above. The method for forming the carbon coating is not particularly limited. For example, a method may be used in which an organic compound that carbonizes upon heating is applied to the surface of the porous silicon, the solvent is removed, and the resulting material is then calcined in an inert or reducing atmosphere It is preferable to use an organic acid as the organic compound. Examples include organic carboxylic acids such as acetic acid, oxalic acid, glycolic acid, oleic acid, linoleic acid, arachidonic acid, phthalic acid, citric acid, isocitric acid, ascorbic acid, lactic acid, malic acid, tartaric acid, and gluconic acid, organic sulfonic acids, organic sulfinic acids, organic complex oxides, organic nitro compounds, and phenolic compounds. Alternatively, an organic acid salt obtained by adding an alkaline compound to any of the organic acids listed above may also be used. Any one or a combination of two or more of these compounds may be used.

One method for applying the organic compound to the surface of the porous silicon is to disperse the porous silicon in a solution of the organic compound and remove the solvent by heating. The calcination may be performed, for example, in a temperature range exceeding 500° C. and up to 900° C. Preferably, the temperature range is from 500° C. to 800° C., more preferably from 550° C. to 700° C., and even more preferably from 600° C. to 650° C.

In this manner, the anode active material of the present disclosure can be produced. In the method for producing the anode active material described above, adjusting the amount of organic compound applied to the porous silicon, the specific surface area of the resulting anode active material can be controlled, and the proportion of the carbon coating relative to the total mass of the porous silicon and the carbon coating can be controlled. The anode active material of the present disclosure has a specific surface area of 130 m²/g or more, preferably 140 m²/g or more, more preferably 145 m²/g or more, and even more preferably 150 m²/g or more. A specific surface area of 130 m²/g or more results in excellent initial charge-discharge efficiency. In the anode active material of the present disclosure, the proportion of the carbon coating is from 1.5 mass % to 12 mass % relative to the total mass of the porous silicon and the carbon coating, preferably from 1.8 mass % to 10 mass %, more preferably from 5.0 mass % to 10 mass %, and even more preferably from 6.0 mass % to 9.0 mass %. A carbon coating proportion of 1.5 mass % to 12 mass % also results in excellent initial charge-discharge efficiency. The specific surface area of the anode active material refers to the BET specific surface area calculated using a gas adsorption method with nitrogen gas. The “BET specific surface area” refers to a value obtained by analyzing the surface area measured by a low-pressure nitrogen gas adsorption method (so-called nitrogen gas adsorption method) using the Brunauer-Emmett-Teller (BET) theory. For such analysis, a commercially available specific surface area measurement device such as “Macsorb Model-1208” (manufactured by Mountech Co., Ltd.) may be used.

In the anode active material of the present disclosure, the specific surface area and the carbon coating proportion are within the ranges defined above. Therefore, the amount of electrolyte that is irreversibly absorbed into the porous silicon can be reduced while maintaining the mechanical strength of the porous silicon.

In the anode active material of the present disclosure, although not particularly limited, the pore volume is preferably from 0.16 cm³/g to 0.45 cm³/g, more preferably from 0.18 cm³/g to 0.30 cm³/g, and even more preferably from 0.20 cm³/g to 0.30 cm³/g. The “pore volume” refers to the volume of mesopores contained in the primary particles, and does not include the volume of voids between the primary particles. The pore volume can be calculated by analyzing the adsorption data of a nitrogen adsorption isotherm using the Barrett-Joyner-Halenda method (BJH method). In the anode active material of the present disclosure, the pore volume is within the range defined above. Therefore, the amount of electrolyte that is irreversibly absorbed into the porous silicon can be reduced while maintaining the mechanical strength of the porous silicon. As a result, even more improved initial charge-discharge efficiency can be achieved.

Furthermore, in the anode active material of the present disclosure, although not particularly limited, it is preferable that the intensity ratio (D/G) between the peak near 1340 cm⁻¹ (D band) and the peak near 1580 cm⁻¹ (G band) in Raman spectroscopic analysis is preferably from 0.670 to 0.725, more preferably from 0.689 to 0.720, and even more preferably from 0.700 to 0.720. In the Raman spectrum of carbon, peaks appear at the G band and the D band. The G band originates from graphite, while the D band originates from structural defects. The above intensity ratio in Raman spectroscopic analysis can be determined by performing Raman spectroscopy using laser light with a wavelength of 532 nm as excitation light, and irradiating the sample with a circular beam having a diameter of 1 μm. For 50 arbitrary measurement points on the same sample, peak intensities of the D band near 1352 cm⁻¹, peak intensities of the G band near 1580 cm⁻¹, and peak intensities of the D′ band near 1620 cm⁻¹ are separated using Voigt functions, and the peak intensities of the D band and the G band are analyzed and used to calculate the intensity ratio. In the anode active material of the present disclosure, the pore volume is within the range defined above. Therefore, the amount of electrolyte that is irreversibly absorbed into the porous silicon can be reduced while maintaining the mechanical strength of the porous silicon. As a result, even more improved initial charge-discharge efficiency can be achieved.

### Anode

The anode of the present disclosure includes: an anode material including the above-described anode active material; and an anode current collector having the anode material disposed on at least one surface thereof.

The anode material contains a binder, a solvent, and other components in addition to the above-described anode active material. The binder is not particularly limited and may be a binder that is conventionally used to prepare an anode slurry. Examples of the binder include butadiene rubber (BR), isobutylene-isoprene rubber (IIR), acrylate-butadiene rubber (ABR), styrene-butadiene rubber (SBR), polyvinylidene fluoride (PVdF), and a polyvinylidene fluoride-hexafluoropropylene copolymer (PVdF-HFP). The solvent is not particularly limited and may be a solvent that is conventionally used to prepare an anode slurry. Examples of the solvent include, but are not limited to, 1,2,3,4-tetrahydronaphthalene, butyl acetate, butyl butyrate, mesitylene, tetralin, heptane, and N-methyl-2-pyrrolidone (NMP).

Other components may include a thickening agent and a conductive additive. Examples of the thickening agent include carboxymethyl cellulose and sodium carboxymethyl cellulose. Examples of the conductive additive include carbon black (such as acetylene black, thermal black, and furnace black), conductive oxides, and conductive nitrides.

The anode slurry can be prepared by mixing and kneading the components such as the above-described anode active material using a stirrer, a ball mill, a super sand mill, a pressure kneader, etc. and adjusting the viscosity as appropriate. The anode can then be produced by applying the resultant anode slurry onto an anode current collector.

### Anode Current Collector

The anode current collector is not particularly limited and may be an anode current collector that is conventionally used to produce anodes. The material of the anode current collector is not particularly limited, and examples include copper (Cu), nickel (Ni), chromium (Cr), gold (Au), platinum (Pt), silver (Ag), aluminum (Al), iron (Fe), titanium (Ti), zinc (Zn), cobalt (Co), and stainless steel. The thickness of the anode current collector is not particularly limited and may be in the range of, for example, 0.1 μm to 1 mm. The anode current collector may be in the form of a strip such as a foil, a perforated foil, or a mesh.

### Lithium-Ion Secondary Battery

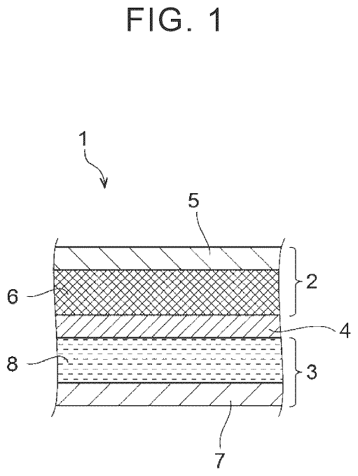

The lithium-ion secondary battery of the present disclosure includes: a cathode including a cathode active material; the anode described above; and an electrolyte layer disposed between the cathode and the anode. As shown in FIG. 1, a lithium-ion secondary battery 1 illustrated as one embodiment includes a cathode layer 2, an anode layer 3, and an electrolyte layer 4 disposed between the cathode layer 2 and the anode layer 3.

The electrolyte layer 4 of the lithium-ion secondary battery 1 may contain a liquid electrolyte but not a solid electrolyte, may contain a solid electrolyte but not a liquid electrolyte, or may contain both a liquid electrolyte and a solid electrolyte. When the electrolyte layer 4 contains a liquid electrolyte, the electrolyte layer 4 preferably includes a separator that retains the liquid electrolyte and maintains separation between the cathode layer 2 and the anode layer 3. When the electrolyte layer 4 contains a solid electrolyte, the electrolyte layer 4 may optionally further contain a binder etc. in addition to the solid electrolyte. In particular, when the anode active material and anode of the present disclosure are used, it is preferable that the electrolyte layer 4 contain a liquid electrolyte but not a solid electrode or contain both a liquid electrolyte and a solid electrolyte.

The solid electrolyte may be any solid electrolyte commonly used in solid-state batteries, without particular limitation. Examples of such solid electrolytes include crystalline nitrides, oxides, sulfides, and oxoacid salts, as well as amorphous materials having a glass structure. In addition to these, complex hydride-based lithium-ion conductors and halide-based lithium-ion conductors may also be used as solid electrolytes.

The liquid electrolyte may be any non-aqueous electrolyte solution commonly used in non-aqueous lithium-ion secondary batteries, without particular limitation. The non-aqueous electrolyte may be a composition including a supporting salt dissolved in a non-aqueous solvent. The non-aqueous solvent may be a material selected from the group consisting of organic electrolytes, fluorinated solvents, propylene carbonate (PC), ethylene carbonate (EC), diethyl carbonate (DEC), dimethyl carbonate (DMC), ethyl methyl carbonate (EMC), and combinations of two or more of these solvents. The supporting salt may be a material selected from the group consisting of Li(FSO₂)₂N, LiPF₆, LiBF₄, LiClO₄, LiAsF₆, LiCF₃SO₃, LiC₄F₉SO₃, LiN(CF₃SO₂)₂, LiC(CF₃SO₂)₃, lithium compounds (lithium salts) of Lil, and combinations of two or more of these.

The separator used with the liquid electrolyte may be any separator commonly used in non-aqueous lithium-ion secondary batteries. Examples of the separator include those containing resins such as polyethylene (PE), polypropylene (PP), polyester, and polyamide. The separator may have a single-layer structure or a multi-layer structure.

### Cathode

The cathode layer 2 includes a cathode current collector 5 and a cathode active material layer 6 containing a cathode active material. The cathode current collector 5 is not particularly limited and may be in the form of a foil, plate, mesh, punched metal, or foam. Examples of metals for the cathode current collector 5 include Cu, Ni, Cr, Au, Pt, Ag, Al, Fe, Ti, Zn, Co, and stainless steel. In particular, from the viewpoint of ensuring oxidation resistance etc, the cathode current collector 5 may contain Al.

The cathode active material is not particularly limited, and conventionally known materials may be used as appropriate. Examples of the cathode active material include LiCoO₂, LiNiO₂, LiMnO₂, LiMn₂O₄, Li(NiCoMn)O₂, Li(NiCoAl)O₂, and LiFePO₄. The cathode active material particles may be a high-nickel material (a cathode active material with a high Ni ratio), an Li—Ni—Co—Mn-based composite oxide, or a ternary cathode active material.

### Anode

The anode layer 3 includes an anode current collector 7 configured as described above and an anode active material layer 8 containing the anode active material of the present disclosure.

### Initial Charge-Discharge Efficiency

The lithium-ion secondary battery of the present disclosure uses the anode active material of the present disclosure. Therefore, the amount of electrolyte that is irreversibly absorbed into the porous silicon can be reduced while maintaining the mechanical strength of the porous silicon. As a result, excellent initial charge-discharge efficiency can be achieved. In the lithium-ion secondary battery of the present disclosure, a high-quality solid electrolyte interphase (SEI) film is formed at the interface between the anode active material and the electrolyte layer. As a result, irreversible consumption of the electrolyte by the SEI film can be reduced, and excellent initial charge-discharge efficiency can be achieved.

The initial charge-discharge efficiency can be calculated as the percentage of the initial discharge capacity relative to the initial charge capacity. Specifically, the initial charge capacity and the initial discharge capacity can be measured using a constant current-constant voltage (CC-CV) method. Charging is performed under the following conditions: a constant current (CC) of 40 mA, a constant voltage (CV) of 4.2 V, and a cutoff current of 4 mA. After a 10-minute rest period, discharging is performed under the following conditions: a constant current (CC) of 40 mA, a constant voltage (CV) of 3 V, and a cutoff current of 4 mA. The initial charge-discharge efficiency can be calculated from the measured initial charge capacity and initial discharge capacity.

Hereinafter, the present disclosure will be described in more detail using examples. However, the technical scope of the present disclosure is not limited to the following examples.

### Example 1

### Anode Active Material

The anode active material was prepared as follows. First, citric acid was ground using a mortar and pestle, and then vacuum-dried overnight at 120° C. Thereafter, the citric acid was dissolved in super-dehydrated ethanol inside a glove box. Porous silicon powder was added to the resulting citric acid solution (at a mass ratio of porous silicon to citric acid of 1:0.5), and the mixture was dispersed using an ultrasonic cleaner for 30 minutes. Next, the dispersion was transferred into a sample container and placed on a hot plate at 60° C. for five hours to remove the ethanol. The sample container was then sealed inside a tea canister and a stainless steel container, which were subsequently placed in a gas-substitution furnace. The atmosphere inside the furnace was replaced with argon gas, and the argon gas was flowed at 1 L/min. The sample was heated to 600° C. at a rate of 10° C./min and held at 600° C. for four hours. After natural cooling, the resulting anode active material was recovered in the glove box. The BET specific surface area, pore volume, and carbon coating ratio of the recovered anode active material were measured. For the anode active material, Raman spectroscopy was performed to measure the peak near 1340 cm⁻¹ (D band) and the peak near 1580 cm⁻¹ (G band), and the intensity ratio (D/G) was calculated.

### Anode

An anode slurry was obtained by mixing the obtained anode active material, polyimide, and single-walled carbon nanotubes (manufactured by OCSiAl) in proportions of 82 mass %, 12 mass %, and 0.6 mass %, respectively. The anode slurry was applied to an anode current collector foil and dried to produce an anode. The anode had a coating weight of 1 mg/cm³.

### Lithium-Ion Secondary Battery

Lithium nickel cobalt manganese oxide (Li(NiMnCo)O₂) was used as a cathode active material. A cathode slurry was prepared by dispersing the cathode active material, a conductive additive, and a binder in a solvent. The slurry was applied to an aluminum (Al) current collector foil and dried to produce a cathode. The anode and cathode thus obtained were arranged to face each other with a separator interposed therebetween. A laminate cell is thus produced. LiPF₆ was added to a solution containing fluoroethylene carbonate (FEC), ethylene carbonate (EC), dimethyl carbonate (DMC), and ethyl methyl carbonate (EMC) to achieve a concentration of 1.2 M, and the resulting electrolyte solution was used. The capacity ratio (anode capacity/cathode capacity) was in the range of 1.0 to 1.1.

The lithium-ion secondary battery thus obtained was evaluated under the following conditions. The cutoff voltage was set to 2.5 V to 4.2 V, cycles 1, 2, 49, 50, 99, and 100 were performed at 0.1 C, while cycles 3 to 48 and 51 to 97 were performed at 1 C. The temperature was 25° C., the total number of cycles was 100, and the applied restraining pressure was approximately 1 MPa (approximately 15 kgf/cm²). The initial charge capacity and the initial discharge capacity were measured, and the initial charge-discharge efficiency was calculated (initial discharge capacity×100)/(initial charge capacity).

### Example 2

Except that the mass ratio of the porous silicon to citric acid was set to 1:2, an anode active material and a lithium-ion secondary battery were produced in the same manner as in Example 1. The BET specific surface area, the intensity ratio (D/G), the pore volume, and the carbon coating ratio were measured, and the initial charge-discharge efficiency was calculated.

### Example 3

Except that the mass ratio of the porous silicon to citric acid was set to 1:5, an anode active material and a lithium-ion secondary battery were produced in the same manner as in Example 1. The BET specific surface area, the intensity ratio (D/G), the pore volume, and the carbon coating ratio were measured, and the initial charge-discharge efficiency was calculated.

### Comparative Example 1

Except that porous silicon was used as the anode active material, a lithium-ion secondary battery was produced in the same manner as in Example 1. The BET specific surface area, the intensity ratio (D/G), the pore volume, and the carbon coating ratio were measured, and the initial charge-discharge efficiency was calculated.

### Comparative Example 2

An anode active material was produced using a mass ratio of porous silicon to citric acid of 1:10, and the BET specific surface area, the intensity ratio (D/G), the pore volume, and the carbon coating ratio were measured.

### Results

As the results of Examples 1 to 3 and Comparative Examples 1, 2, the mass ratio of porous silicon to citric acid, the carbon coating ratio (mass %), the BET specific surface area (m²/g), and the intensity ratio (D/G) are shown in Table 1.

TABLE 1

| | Porous | Carbon | | |
|---|---|---|---|---|
| | Silicon:Citric | Coating | BET Specific | Intensity |
| | Acid | Ratio | Surface Area | Ratio (D/G) |
| Comparative | — | 0.33 | 129.2 | — |
| Example 1 | | | | |
| Example 1 | 1:0.5 | 1.88 | 149.3 | 0.689 |
| Example 2 | 1:2 | 6.30 | 154.0 | 0.720 |
| Example 3 | 1:5 | 8.82 | 151.5 | 0.701 |
| Comparative | 1:10 | 14.20 | 159.4 | 0.700 |
| Example 2 | | | | |

The measurement results of the pore volume (cm³/g) and the calculation results of the initial charge-discharge efficiency for the obtained anode active materials are shown in Table 2. In Comparative Example 2, carbon agglomerates were formed, which caused dragging during the application of the anode slurry to the anode current collector. Therefore, it was impossible to produce a lithium-ion secondary battery.

TABLE 2

| | | Initial Charge- |
|---|---|---|
| | Pore Volume | Discharge Efficiency |
| Comparative Example 1 | 0.75 | 41.40 |
| Example 1 | 0.39 | 48.80 |
| Example 2 | 0.24 | 51.10 |
| Example 3 | 0.17 | 47.20 |
| Comparative Example 2 | 0.15 | — |

From the results shown in Tables 1 and 2, it can be understood that the initial charge-discharge efficiency is improved by using an anode active material that contains porous silicon having a carbon coating, a specific surface area of 130 m²/g or more, and a carbon coating ratio of 1.5 mass % to 12 mass % relative to the total mass of the porous silicon and the carbon coating. It was also found that the pore volume of the anode active material is preferably in the range of 0.16 cm³/g to 0.45 cm³/g. Furthermore, it was found that the intensity ratio (D/G) in Raman spectroscopy is preferably in the range of 0.670 to 0.725.

What is claimed is:

1. An anode active material comprising:
porous silicon; and
a carbon coating disposed on at least part of a surface of the porous silicon,
wherein a specific surface area is 130 m²/g or more, and a proportion of the carbon coating is in a range of 1.5 mass % to 12 mass % relative to total mass of the porous silicon and the carbon coating.

2. The anode active material according to claim 1, wherein a pore volume is in a range of 0.16 cm³/g to 0.45 cm³/g.

3. The anode active material according to claim 1, wherein an intensity ratio of D to G in Raman spectroscopy is in a range of 0.670 to 0.725, where D represents a peak at a D band near 1340 cm⁻¹ and G represents a peak at a G band near 1580 cm⁻¹.

4. An anode comprising:
an anode material including the anode active material according to claim 1; and
an anode current collector having the anode material disposed on at least one surface of the anode current collector.

5. A lithium-ion secondary battery comprising:
a cathode including a cathode active material;
the anode according to claim 4; and
an electrolyte layer disposed between the cathode and the anode.
